(19) United States
(12) Patent Application Publication
(10) Pub. No.: US 2019/0301961 A1
(43) Pub. Date: Oct. 3, 2019

(54) LOAD FRAME WITH A STAGED BIASING ELEMENT

(71) Applicant: Actuant Corporation, Menomonee Falls, WI (US)

(72) Inventor: Nick Joseph Tolley, Wauwatosa, WI (US)

(21) Appl. No.: 16/372,735

(22) Filed: Apr. 2, 2019

Related U.S. Application Data
(60) Provisional application No. 62/651,383, filed on Apr. 2, 2018.

(51) Int. Cl. G01L 25/00; G01L 5/00

(52) U.S. Cl. CPC G01L 25/00; G01L 5/0066

(57) ABSTRACT

A load frame for calibrating a load cell includes a first member positioned adjacent the load cell, a second member spaced apart from the first member, and a staged biasing element positioned between the first member and the second member. The staged biasing element exerts a first biasing force between the first member and the second member in a first range of test loads, and exerts a second biasing force between the first member and the second member in a second range of test loads.

### REFERENCE TO RELATED APPLICATION

This application claim the benefit of co-pending, prior-filed U.S. Provisional Patent Application No. 62/651,383, filed Apr. 2, 2018, the entire contents of which are incorporated by reference.

### FIELD

The present disclosure relates to a load frame and, more specifically, to a load frame for calibrating a load cell.

### BACKGROUND

Calibration frames frequently include multiple stacked plates or members between which one or more load cells can be positioned. The frame includes an adjustment device, such as a threaded shaft, to modify the load that is applied on the load cell(s).

### SUMMARY

In one embodiment, a load frame for calibrating a load cell includes a first member positioned adjacent the load cell, a second member spaced apart from the first member, and a staged biasing element positioned between the first member and the second member. The staged biasing element exerts a first biasing force between the first member and the second member in a first range of test loads, and exerts a second biasing force between the first member and the second member in a second range of test loads.

In another embodiment, a load frame for calibrating a load cell includes a first member adjacent the load cell, a second member spaced apart from the load cell, a first biasing member, and a second biasing member. The first biasing member includes at least one first spring positioned between the first member and the second member, and the first biasing member has a first stiffness and a first unbiased length. The first biasing member exerts a first biasing force on the first member and the second member in a first range of test loads. The second biasing member includes at least one second spring positioned between the first member and the second member, and the second biasing member has a second stiffness less than the first stiffness and a second unbiased length greater than the first unbiased length. The first biasing member and the second biasing member exert a second biasing force on the first member and the second member in a second range of test loads.

In still another embodiment, a load frame for calibrating a load cell includes a first member positioned adjacent the load cell, a second member spaced apart from the first member, and a biasing element positioned between the first member and second member. The first member is movable in a first direction relative to the second member to engage the biasing element and exert a biasing force on the second member, and the second member is movable in a second direction opposite the first direction and relative to the first member to engage the biasing element and exert a biasing force on the first member.

In yet another embodiment, a staged biasing element includes a body, a first biasing member, and a second biasing member. The first biasing member is coupled to the body and has a first stiffness and a first unbiased length. The first biasing member is operable to exert a first biasing force. The second biasing member is coupled to the body and has a second stiffness and a second unbiased length. The first biasing member and the second biasing member are operable to exert a second biasing force.

Other aspects of the disclosure will become apparent by consideration of the detailed description and accompanying drawings.

### BRIEF DESCRIPTION OF THE DRAWINGS

FIG. 1 is a perspective view of a load frame.

FIG. 2 is a cross-sectional view of the load frame of FIG. 1, viewed along section 2-2.

FIG. 3 is a perspective view of a biasing element.

FIG. 4 is a side view of the load frame of FIG. 1 in an unbiased state.

FIG. 5 is a side view of the load frame of FIG. 1, in a first position of a first test state.

FIG. 6 is a side view of the load frame of FIG. 1, in a second position of the first test state.

FIG. 7 is a side view of the load frame of FIG. 1, in a third position of the first test state.

FIG. 8 is a side view of the load frame of FIG. 1, in a first position of a second test state.

FIG. 9 is a side view of the load frame of FIG. 1, in a second position of the second test state.

FIG. 10 is a side view of the load frame of FIG. 1, in a third position of the second test state.

### DETAILED DESCRIPTION

Before any embodiments are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. Use of “including” and “comprising” and variations thereof as used herein is meant to encompass the items listed thereafter and equivalents thereof as well as additional items. Use of “consisting of” and variations thereof as used herein is meant to encompass only the items listed thereafter and equivalents thereof. Unless specified or limited otherwise, the terms “mounted,” “connected,” “supported,” and “coupled” and variations thereof are used broadly and encompass both direct and indirect mountings, connections, supports, and couplings.

In general, the present disclosure relates to a calibration frame including a progressive or staged biasing element. The biasing element can be configured to exert a wide range of biasing forces on a load cell within a comparatively narrow range of movement for the load frame members.

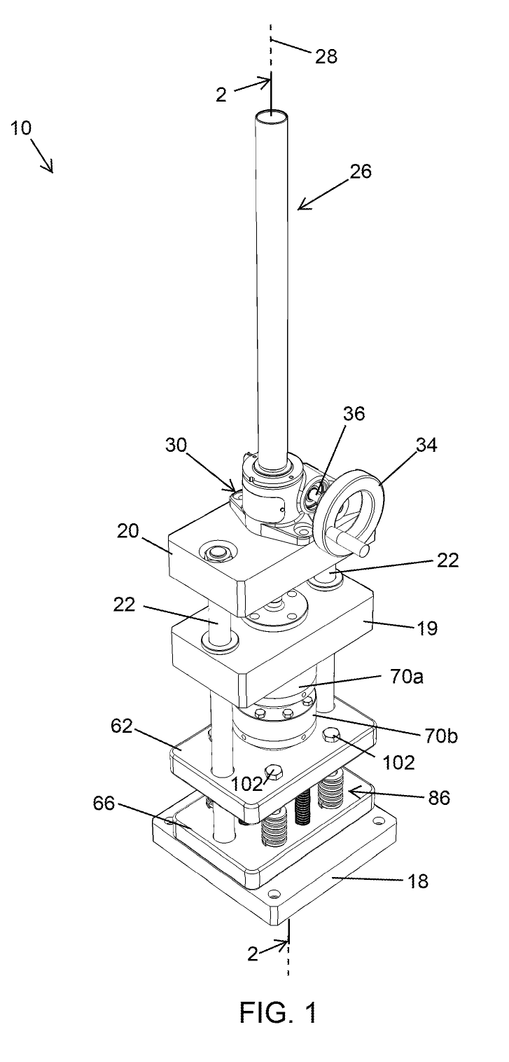

As shown in FIG. 1, a load frame 10 includes a base 12, a intermediate portion 16, and a control portion 20. The intermediate portion 16 is disposed between the base 12 and the control portion 20, and the intermediate portion 16 is spaced apart from the base 12 and the control portion 20. In the illustrated embodiment, the base 12 and the control portion 20 are fixed against movement relative to one another and the intermediate portion 16 is movable with respect to the control portion 20 and the base 12.

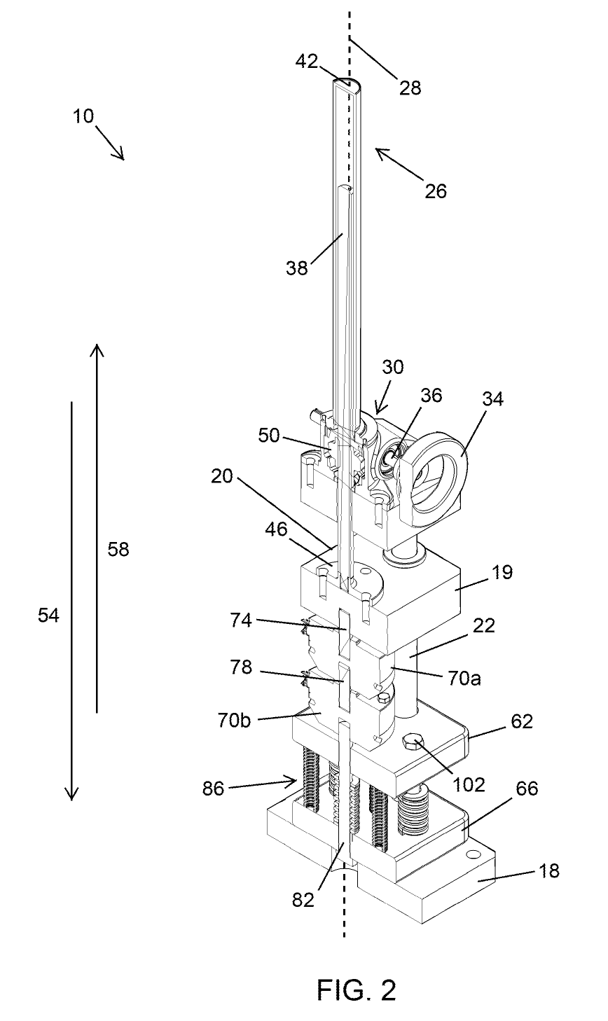

Support members or support rods 22 extend parallel with respect to each other between the base 12 and the control portion 20, and one end of each rod 22 is rigidly secured to the base 12 and the other end of each rod 22 is rigidly secured to the control portion 20. An adjustment rod 26 extends from the intermediate portion 16 and through the control portion 20 (FIG. 2) and defines an axis 28. In the illustrated embodiment, the adjustment rod 26 is disposed substantially in a center of the base 12 and the support rods 22 are disposed symmetrically about the adjustment rod 26.

The control portion 20 supports a control housing 30 and a control member. The adjustment rod 26 extends through the control housing 30, and the control member is supported by the control housing 30 to maintain engagement with the adjustment rod 26. In the illustrated embodiment, the control member includes a wheel 34 connected to drive member (e.g., a threaded shaft—not shown) that engages the adjustment rod 26 through an adjustment mechanism 36.

As shown in FIG. 2, the adjustment rod 26 includes a shaft 38 and, in the illustrated embodiment, a casing 42 is disposed around a portion of the shaft 38. One end of the shaft 38 is coupled to a flange 46 on the intermediate portion 16, and the shaft 38 extends through the control housing 30. The casing 42 is coupled to the control housing 30. In the illustrated embodiment, the control housing 30 includes a worm gear 50. The worm gear 50 engages the drive member, which is rotated by the wheel 34. The worm gear 50 interfaces with the shaft 38 to rotate the shaft 38 when the gear 50 rotates. Rotation of the wheel 34 therefore actuates the gear drive to cause translational (e.g., vertical) movement of the shaft 38. For example, rotation of the wheel 34 in a first rotational direction (e.g., clockwise) causes the shaft 38 to move relative to the control portion 20 in a first direction 54 (e.g., toward the base 12), while rotation of the wheel 34 in a second rotational direction (e.g., counterclockwise) causes the shaft 38 to move relative to the control portion 20 in a second direction 58 (e.g., away from the base 12). Movement of the shaft 38 causes movement of the intermediate portion 16 in the same direction. In other embodiments, the load frame 10 may be actuated in another manner—for example, the intermediate portion 16 could be moved by a hydraulic actuator such as a ram or cylinder.

Returning to FIG. 1, the load frame 10 also includes a first portion or platen 62 and a second portion or platen 66. The platens 62, 66 are substantially rectangular in shape and are disposed between the base 12 and the intermediate portion 16. The second platen 66 is disposed proximate the base 12 and the first platen 62 is disposed between the intermediate portion 16 and the second platen 66 intermediate portion 16.

As shown in FIG. 2, load cells 70 to be calibrated can be disposed between the first platen 62 and the intermediate portion 16. In the illustrated embodiment, the load frame 10 accommodates two load cells (a first load cell 70a and a second load cell 70b) in a stacked or vertically aligned configuration. The load cells 70a, 70b are aligned with the adjustment rod 26. In the illustrated embodiment, the first load cell 70a is rigidly coupled to the intermediate portion 16 by a first pin 74, and the second load cell 70b is rigidly coupled to the first load cell 70a by a second pin 78. The pins 74, 78 enable the intermediate portion 16 and the load cells 70a, 70b to move together, relative to the base 12. Furthermore, in the illustrated embodiment, a first bolt 82 extends through the base 12 and extends through the platens 62, 66, and is coupled to the second load cell 70b.

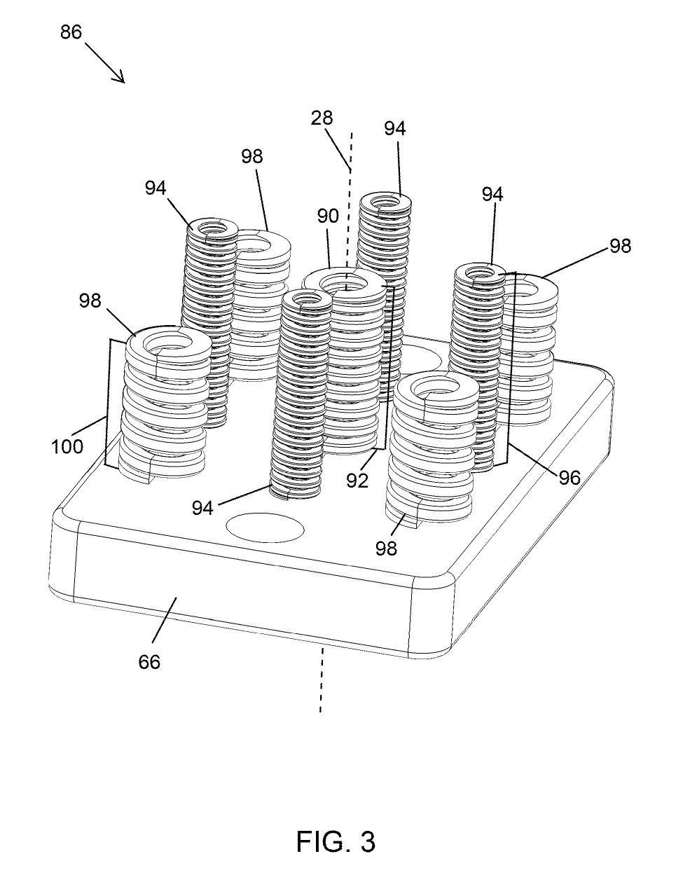

As shown in FIG. 3, the load frame 10 further includes a biasing element 86 including a plurality of staged biasing members. In the illustrated embodiment, the biasing members include springs 90, 94, 98. The term “biasing member” may refer to a particular set or stage of springs, whether the set or stage includes a single spring or multiple springs. Stated another way, “biasing member” may refer collectively to all of the individual springs that form a particular set or stage. The springs 90, 94, 98 are positioned between the first platen 62 and the second platen 66. In the illustrated embodiment, springs 90, 94, 98 are spaced apart from one another at various positions relative to the axis 28.

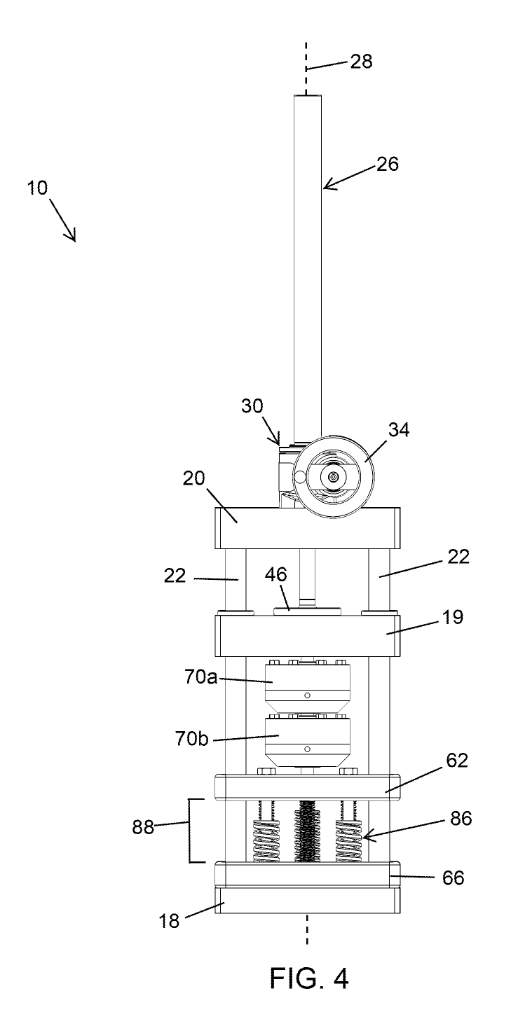

Referring to FIG. 3, the load frame 10 includes a first biasing member including a first spring 90, a second biasing member including second springs 94, and a third biasing member including third springs 98. In the illustrated embodiment, the first spring 90 is coaxial with the first bolt 82 (e.g., is positioned around the first bolt 82). The first spring 90 includes a first nominal length or unbiased length 92 that is less than a nominal or unbiased length 88 between the platens 62, 66 (FIG. 4). The first spring 90 also includes a first stiffness (i.e., a first spring constant).

In the illustrated embodiment, the load frame 10 includes four second springs 94 arranged about the first spring 90. The second springs 94 are equally spaced apart from each other and from the first spring 90. In the illustrated embodiment, the second springs 94 are disposed proximate a middle of the side edges of platens 62, 66. The second springs 94 include a second nominal or unbiased length 96 that is greater than the first unbiased length 92 and equal to the unbiased length 88 between the platens 62, 66. The second springs 94 also include a second stiffness (i.e., a second spring constant) that is less than the first stiffness of the first spring 90.

In the illustrated embodiment, the load frame 10 includes four third springs 98 arranged about the first spring 90. The third springs 98 are equally spaced apart from each other and from the first spring 90. In the illustrated embodiment, the third springs 98 are disposed proximate corners of the platens 62, 66 so that the second springs 94 are arranged between each adjacent pair of third springs 98. Stated another way, the second and third springs 94, 98 are arranged in an alternating pattern. Second bolts 102 (FIG. 1) extend between the first platen 62 and the base 12, and each second bolt 102 passes through an associated one of the third springs 98. The third springs 98 include a third nominal or unbiased length 100 that is less than the first unbiased length 92. The third springs 98 also include a third stiffness (i.e., a third spring constant) that is greater than the first stiffness of the first spring 90.

In other embodiments, the biasing element 86 may include fewer or more of the first spring, second springs, and third springs. Also, in other embodiments, the springs may be positioned in a different configuration. Furthermore, in other embodiments, the biasing element 86 may include fewer or more types or stages of springs, and the stiffnesses and lengths of the springs in each of the stages could be configured in a different manner.

As shown in FIG. 4, the platens 62, 66 are nominally spaced apart by the unbiased length L when in an unbiased state. In the unbiased state, springs 90, 94, 98 are each positioned at their unbiased length 92, 96, 100 (i.e., only the second springs 94 are in contact with both platens 62, 66). In some embodiments, the stiffness of the second springs 94 is sufficient that the weight of the load cells 70, first platen 62, and intermediate portion 16 does not deform the second springs 94 in the unbiased state.

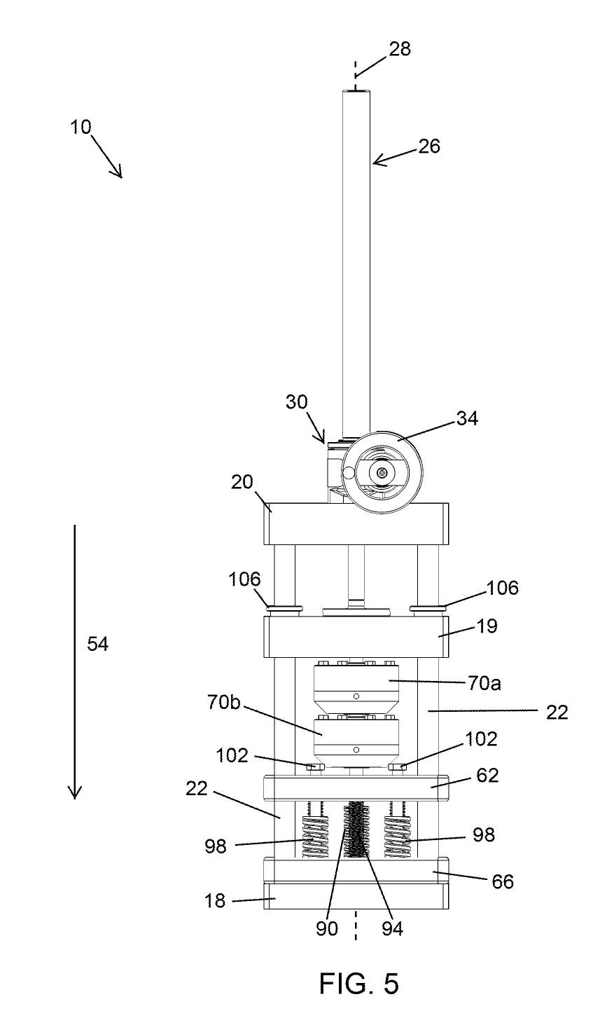

As shown in FIG. 5, the wheel 34 is rotatable to a first position in a first test state (i.e., a compressive load configuration) so that the shaft 38 (FIG. 2) applies a force to the intermediate portion 16 in the first direction 54. The intermediate portion 16 is slidable along the support rods 22 and transmits the force to the load cells 70a, 70b. Since the first platen 62 is coupled to both the intermediate portion 16 and load cells 70a, 70b, the force causes the first platen 62 to move against the biasing element 86 (e.g., by sliding along the support rods 22 and second bolts 102 in the first direction 54). The biasing element 86 provides a reaction force on the first platen 62, thereby creating a compressive load on the load cells 70a, 70b.

Since the second platen 66 is in contact with the base and prevented from moving in the direction 54, movement of the first platen 62 in the first direction 54 reduces the distance between the platens 62, 66 so that the platens 62, 66 are no longer spaced apart by the nominal distance 88. The movement of the first platen 62 also applies a compressive force to the second springs 94, thereby compressing the second springs 94 and reducing their length from the unbiased length 96. The second springs 94 act in parallel to one another and exert a first biasing force on the second platen 66. In some embodiments, the first biasing force is substantially linearly related to the displacement of the first platen 62.

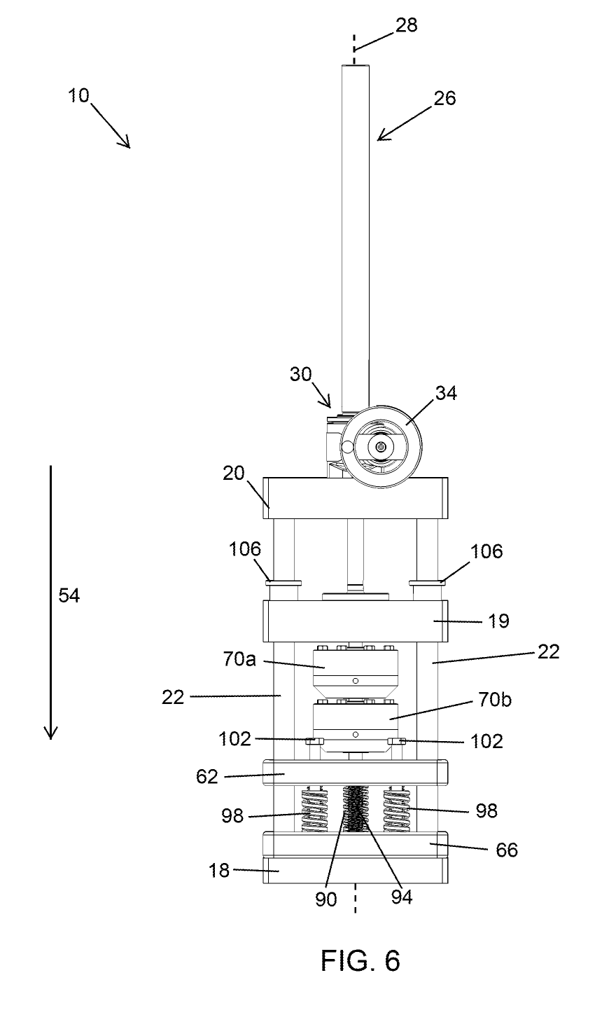

As shown in FIG. 6, the wheel 34 is further rotatable in the same direction to a second position so that the shaft 38 (FIG. 2) urges the intermediate portion 16 further in the first direction 54. As a result, the first platen 62 is urged further against the biasing element 86, which provides a reaction force on the first platen 62 to increase the compressive load on the load cells 70a, 70b.

Further movement of the first platen 62 in the first direction 54 further reduces the distance between the platens 62, 66 and further compresses the second springs 94. In the second position, the length of the second springs 94 is equal to or less than the unbiased length 92, and the first platen 62 also engages the first spring 90. The first platen 62 compresses the first spring 90 so that the first spring 90 and the second springs 94 have the same length in the second position.

The first spring 90 and the second springs 94 act in parallel to provide a second biasing force to the second platen 66. The second biasing force is greater than the first biasing force because the second position includes the engagement of the additional parallel spring 90. In some embodiments, the second biasing force is substantially linearly related to the displacement of the first platen, but includes a steeper slope than the first biasing force. The first spring 90 has a higher stiffness (i.e., slope of the biasing force) than the second springs 94, and the effective spring constant of the combined first and second springs 90, 94 is greater than the effective spring constant of just the second springs 94.

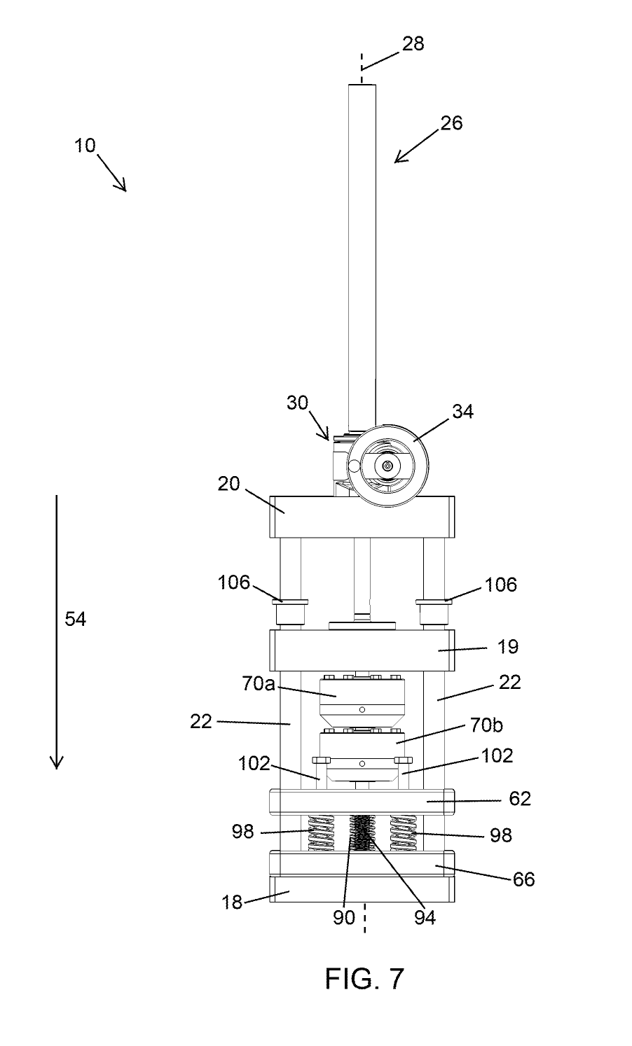

As shown in FIG. 7, rotating the wheel 34 even further in the same direction to a third position causes the shaft 38 (FIG. 2) to urge the intermediate portion 16 further in the first direction 54. As a result, the first platen 62 is urged further against the biasing element 86, which provides a reaction force on the first platen 62 to increase the compressive load on the load cells 70a, 70b.

Further movement of the first platen 62 in the first direction 54 further reduces the distance between the platens 62, 66 and further compresses the first and second springs 90, 94. In the third position, the length of the first and second springs 90, 94 is equal to or less than the unbiased length 100, and the first platen 62 also engages the third springs 98. The first platen 62 compresses the third springs 98 so that the first spring 90, the second springs 94, and the third springs 98 have the same length in the third position.

The first spring 90, the second springs 94, and the third springs 98 act in parallel to provide a third biasing force to the second platen 66. The third biasing force is greater than the second biasing force because the third position includes the engagement of additional parallel springs 98. In some embodiments, the third biasing force is substantially linearly related to the displacement of the first platen 62, but includes a steeper slope than the second biasing force. The third springs 98 have higher stiffnesses (i.e., slope of the biasing force) than the second springs 94 or the first spring 90, and the effective spring constant of the combined first springs 90, second spring 94, and third springs 98 is greater than the effective spring constant of just the combined first and second springs 90, 94.

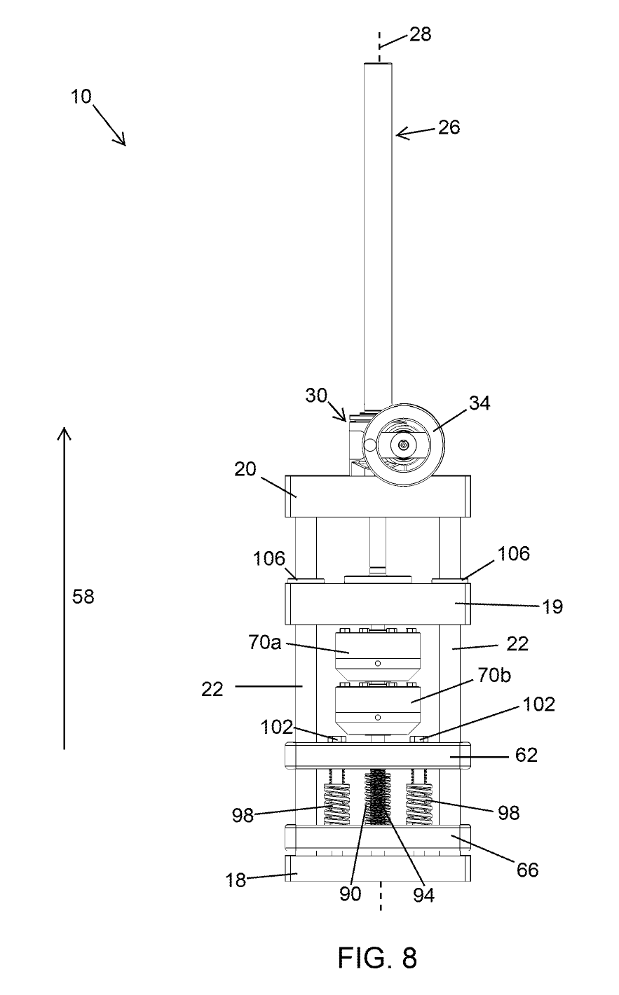

As shown in FIG. 8, the wheel 34 is rotatable to a first position in a second test state (i.e., a tensile load condition) so that the shaft 38 (FIG. 2) applies a force to the intermediate portion 16 in the second direction 58 (e.g., the shaft 38 pulls the intermediate portion 16). One or more stop surfaces can be provided to prevent the intermediate portion 16 from moving beyond a predetermined position in the second direction 58. In the illustrated embodiment, flanges 106 are positioned on the support rods 22 to provide stop surfaces. The intermediate portion 16 and load cells 70a, 70b together apply a force on the first platen 62, which is also prevented from moving in the second direction 58 beyond a predetermined position by heads of the second bolts 102. The stop surfaces (i.e., the flanges 106 and the second bolts 102) prevent the first platen 62 and the intermediate portion 16 from moving. The first bolt 82 urges the second platen 66 toward the first platen 62. In the illustrated embodiment, an end of the first bolt 82 includes a flange that engages the second platen 66 and moves the second platen 66 against the biasing element 86 (e.g., by sliding along the support rods 22 in the second direction 58). The biasing element 86 provides a reaction force on the second platen 66, thereby creating a tensile load on the cells 70a, 70b.

Since the first platen 62 is in contact with the heads of the bolts 102 and prevented from moving in the second direction 58, movement of the second platen 66 in the second direction 58 reduces the distance between the platens 62, 66 so that the platens 62, 66 are no longer spaced apart by the nominal distance 88. The movement of the second platen 66 also applies a compressive force to the second springs 94, thereby compressing the second springs 94 and reducing their length from the unbiased length 96. The second springs 94 act in parallel to one another and exert a first biasing force on the first platen 62. In some embodiments, the first biasing force is substantially linearly related to the displacement of the second platen 66.

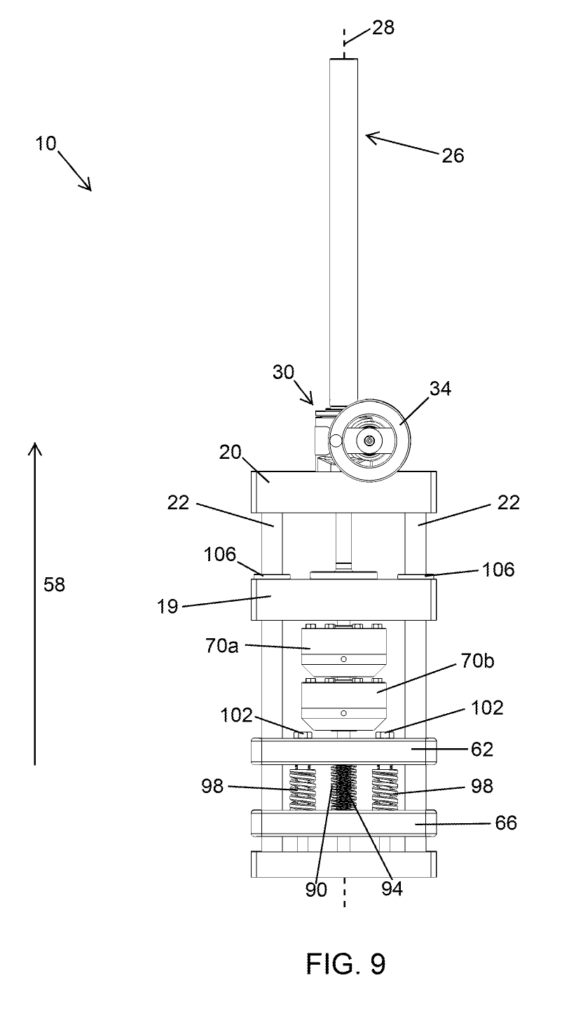

As shown in FIG. 9, the wheel 34 is further rotatable in the same direction to a second position so that the shaft 38 (FIG. 2) applies a force on the intermediate portion 16 further in the second direction 58. The stop surfaces 102, 106 continue to prevent the first platen 62 from moving in the second direction 58, and as a result, the second platen 66 is urged further against the biasing element 86, which provides a reaction force on the second platen 66 to increase the tensile load on the load cells 70a, 70b.

Further movement of the second platen 66 in the second direction 58 further reduces the distance between the platens 62, 66 and further compresses the second springs 94. In the second position, the length of the second springs 94 is equal to or less than the unbiased length 92 and the second platen 66 also engages the first spring 90. The second platen 66 compresses the first spring 90 so that the first spring 90 and the second springs 94 have the same length in the second position.

The first spring 90 and the second springs 94 act in parallel to provide a second biasing force to the first platen 62. The second biasing force is greater than the first biasing force because the second position includes the engagement of the additional parallel spring 90. In some embodiments, the second biasing force is substantially linearly related to the displacement of the second platen, but includes a steeper slope than the first biasing force. The first spring 90 has a higher stiffness (i.e., slope of the biasing force) than the second springs 94, and the effective spring constant of the combined first and second springs 90, 94 is greater than the effective spring constant of just the second springs 94.

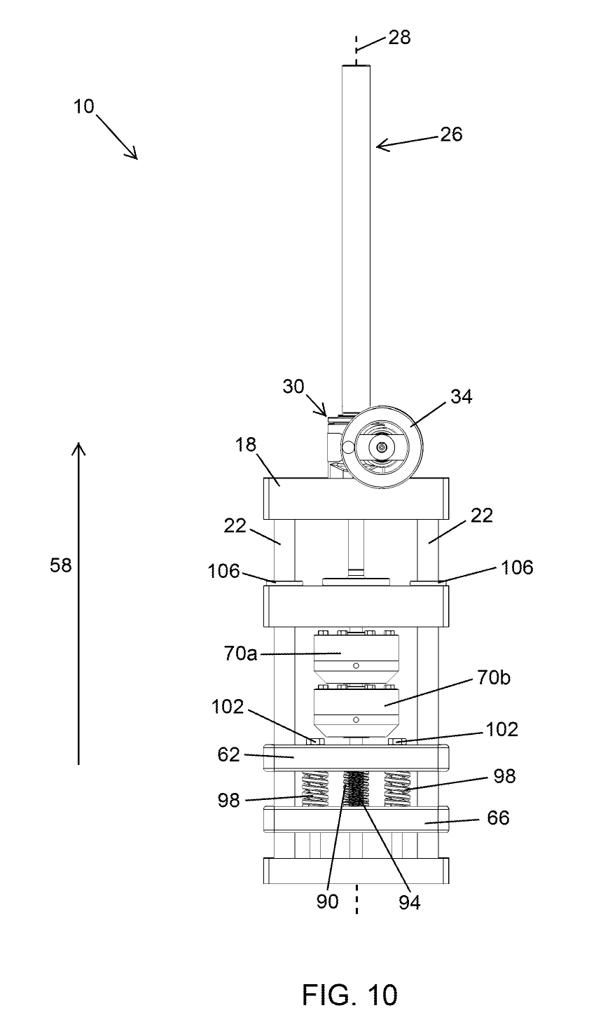

As shown in FIG. 10, rotating the wheel 34 even further in the same direction to a third position causes the shaft 38 (FIG. 2) applies a force on the intermediate portion 16 in the second direction 58. The stop surfaces 102, 106 continue to prevent the first platen 62 from moving in the second direction 58, and as a result, the second platen 66 is urged further against the biasing element 86, which provides a reaction force on the second platen 66 to increase the tensile load on the load cells 70a, 70b.

Further movement of the second platen 66 in the second direction 58 further reduces the distance between the platens 62, 66 and further compresses the first and second springs 90, 94. In the third position, the length of the first and second springs 90, 94 is equal to or less than the unbiased length 100 and the second platen 66 also engages the third springs 98. The second platen 66 compresses the third springs 98 so that the first spring 90, the second springs 94, and the third springs 98 have the same length in the third position.

The first spring 90, the second springs 94, and the third springs 98 act in parallel to provide a third biasing force to the first platen 62. The third biasing force is greater than the second biasing force because the third position includes the engagement of additional parallel springs 98. In some embodiments, the third biasing force is substantially linearly related to the displacement of the second platen 66, but includes a steeper slope than the second biasing force. The third springs 98 have higher stiffnesses (i.e., slope of the biasing force) than the second springs 94 or the first spring 90, so the effective spring constant of the combined first springs 90, second spring 94, and third springs 98 is greater than the effective spring constant of just the combined first and second springs 90, 94.

In either the first test state (FIGS. 5-7) or the second test state (FIGS. 8-10), the biasing element 86 acts as a staged biasing element. The system stiffness of the load frame 10 (i.e., the effective spring constant of all of the engaged springs) progressively increases as the test load increases. Among other things, the load frame may incorporate a coarser thread (not shown) in the worm gear 50 (FIG. 2) while still maintaining high accuracy. The coarser thread allows for the platens 62, 66 to be moved further with each revolution of the wheel 34, which reduces the amount of manual exertion required by an operator. The staged biasing element 86 also reduces the amount of adjustment (i.e., rotation of the wheel 34) to configure the load cells at each desired calibration point, thereby reducing the amount of manual effort and setup time required for calibration. The staged biasing element 86 can handle a large range of loads in either compression or tension, so only small adjustments of the wheel 34 are necessary.

In either test state, the load cells 70a, 70b each independently measure the biasing force exerted on the platens 62, 66. These measurements are used to calibrate the load cells 70a, 70b. The staged biasing element 86 allows a user to calibrate the load cells 70a, 70b across a wide range of biasing loads.

The embodiment(s) described above and illustrated in the figures are presented by way of example only and are not intended as a limitation upon the concepts and principles of the present disclosure. As such, it will be appreciated that variations and modifications to the elements and their configuration and/or arrangement exist within the spirit and scope of one or more independent aspects as described.

1. A load frame for calibrating a load cell, the frame comprising:
a first member positioned adjacent the load cell;
a second member spaced apart from the first member; and
a staged biasing element positioned between the first member and the second member, the staged biasing element exerting a first biasing force between the first member and the second member in a first range of test loads, and exerting a second biasing force between the first member and the second member in a second range of test loads.

2. The load frame of claim 1, wherein the staged biasing element includes,
a first spring having a first stiffness;
a second spring having a second stiffness, wherein the second stiffness is less than the first stiffness; and
a third spring having a third stiffness, wherein the third stiffness is greater than the first stiffness.

3. The load frame of claim 2, wherein the staged biasing element includes four second springs arranged symmetrically around the first spring and four third springs arranged symmetrically around the first spring, wherein each spring is spaced apart from other springs.

4. The load frame of claim 3, wherein the third springs are positioned proximate an outer periphery of the second member and each second spring is disposed between adjacent third springs.

5. The load frame of claim 2, wherein the second spring is coupled to the first member and the second member, and wherein the first spring and the third spring are coupled to the second member and not the first member.

6. The load frame of claim 2, wherein the first spring has a first length, the second spring has a second length greater than the first length, and the third spring has a third length less than the first length.

7. The load frame of claim 1, further comprising
a first test state for calibrating the load cell, wherein the first member moves in a first direction relative to the second member and engages the staged biasing element to exert one of the first biasing force and the second biasing force on the second member; and
a second test state for calibrating the load cell, wherein the second member moves in a second direction opposite the first direction and relative to the first member and engages the staged biasing element to exert one of the first biasing force and the second biasing force on the first member.

8. The load frame of claim 7, further comprising a base and a bolt coupled to the base and the first and second members, wherein
the first member moves toward the second member in the first direction, the base provides a stop surface for the second member to limit movement in of the second member in the first direction; and
the second member moves toward the first member in the second direction, a head of the bolt provides a stop surface for the first member to limit movement of the first member in the second direction.

9. The load frame of claim 1, wherein the staged biasing element is coupled to the second member.

10. A load frame for calibrating a load cell, the frame comprising:
a first member adjacent the load cell;
a second member spaced apart from the load cell;
a first biasing member including at least one first spring positioned between the first member and the second member, the first biasing member having a first stiffness and a first unbiased length, the first biasing member exerting a first biasing force on the first member and the second member in a first range of test loads; and
a second biasing member including at least one second spring positioned between the first member and the second member, the second biasing member having a second stiffness less than the first stiffness and a second unbiased length greater than the first unbiased length, the first biasing member and the second biasing member exerting a second biasing force on the first member and the second member in a second range of test loads.

11. The load frame of claim 10, wherein the second biasing member includes a plurality of second springs and the first biasing member includes one first spring, the load frame further comprising a rod extending between the first and second members, wherein the first spring is disposed around the rod, and the second springs are equally spaced apart from one another about the rod.

12. The load frame of claim 10, further comprising a third biasing member including at least one third spring positioned between the first member and the second member, the third biasing member having a third stiffness that is greater than the first stiffness and a third unbiased length that is less than the first unbiased length, wherein the at least one first spring, the at least one second spring, and the at least one third spring exert a third biasing force on the members in a third range of test loads.

13. The load frame of claim 12, wherein the third biasing member includes a plurality of third springs that are equally spaced apart from one another about the first spring and are positioned between the second springs.

14. The load frame of claim 10, further comprising,
a first test state for calibrating the load cell, wherein the first member moves in a first direction relative to the second member and engages the at least one first spring to exert the first biasing force on the second member; and
a second test state for calibrating the load cell, wherein the second member moves in a second direction opposite the first direction and relative to the first member and engages the at least one first spring to exert the first biasing force on the first member.

15. The load frame of claim 14, further comprising a base and a bolt coupled to the base and the first and second members, wherein
the first member moves toward the second member in the first direction, the base provides a stop surface for the second member to limit movement in of the second member in the first direction; and
the second member moves toward the first member in the second direction, a head of the bolt provides a stop surface for the first member to limit movement of the first member in the second direction.

16. A load frame for calibrating a load cell, the frame comprising:
a first member positioned adjacent the load cell;
a second member spaced apart from the first member; and
a biasing element positioned between the first member and second member, the first member movable in a first direction relative to the second member to engage the biasing element and exert a biasing force on the second member, and the second member movable in a second direction opposite the first direction and relative to the first member to engage the biasing element and exert a biasing force on the first member.

17. The load frame of claim 16, wherein the biasing element is a staged biasing element that exerts a first biasing force on the members in a first range of test loads, and exerts a second biasing force on the members in a second range of test loads.

18. The load frame of claim 16, wherein the biasing element is a staged biasing element, the load frame further comprises,
a first spring having a first stiffness and a first length;
a second spring having a second stiffness and a second length, wherein the second stiffness is less than the first stiffness and the second length is greater than the first length; and
a third spring having a third stiffness and a third length, wherein the third stiffness is greater than the first stiffness and the third length is less than the first length.

19. The load frame of claim 18, wherein the second spring is one of a plurality of second springs and the third spring is one of a plurality of third springs, wherein the plurality of second springs and the plurality of third springs are disposed in an alternating pattern around the first spring.

20. The load frame of claim 16, further comprising a base and a bolt coupled to the base and the first and second members, wherein
the first member moves toward the second member in the first direction, the base provides a stop surface for the second member to limit movement in of the second member in the first direction; and
the second member moves toward the first member in the second direction, a head of the bolt provides a stop surface for the first member to limit movement of the first member in the second direction.

21-29. (canceled)
